(19) United States
(12) Patent Application Publication
(10) Pub. No.: US 2022/0013934 A1
(43) Pub. Date: Jan. 13, 2022

(54) CABLE CONNECTOR FOR COAXIAL CABLE, COAXIAL CABLE ASSEMBLY AND MANUFACTURING METHOD THEREOF

(71) Applicant: CommScope Technologies LLC, Hickory, NC (US)

(72) Inventors: JianPing Wu, Suzhou (CN); Jin Liu, Suzhou (CN); Hongjuan An, Suzhou (CN); Yujun Zhang, Suzhou, (CN)

(21) Appl. No.: 17/346,365

(22) Filed: Jun. 14, 2021

(30) Foreign Application Priority Data
Jul. 8, 2020 (CN) 202010648743.5

(51) Int. Cl. H01R 9/05

(52) U.S. Cl. CPC H01R 9/0518; H01R 9/0503

(57) ABSTRACT

The invention relates to a cable connector for a coaxial cable, including an inner conductor (1) having a proximal section with a receiving hole (6) configured to receive a free end of an inner conductor of a coaxial cable; an outer conductor (2) having a distal chamber (7) and a proximal chamber (8) configured to receive an end section of the coaxial cable; and an insulator (3) for insulating the inner conductor from the outer conductor of the cable connector, the insulator being received in the distal chamber. At least the proximal section of the inner conductor of the cable connector comprises lead brass, and the proximal section can be pressed for grasping the free end of the inner conductor of the coaxial cable. The invention also relates to a coaxial cable assembly including such a cable connector and a method for manufacturing the same. The cable connector can be manufactured cost-effectively and reliable connection between the cable connector and the coaxial cable can be ensured.

### RELATED APPLICATION

The present application claims priority from and the benefit of Chinese Patent Application No. 202010648743.5, filed Jul. 8, 2020, the disclosure of which is hereby incorporated herein by reference in its entirely.

### FIELD OF THE INVENTION

The present disclosure relates to the technical field of cable connection. More specifically, the disclosure relates to a cable connector for a coaxial cable, a coaxial cable assembly including the same, and a method for manufacturing the coaxial cable assembly.

### BACKGROUND OF THE INVENTION

A cable connector for a coaxial cable is generally known. Typically, a known cable connector may have an inner conductor, an outer conductor and an insulator for insulating the inner conductor from the outer conductor. The inner conductor may have a proximal section which may have a receiving hole or bore configured to receive a free end of an inner conductor of a coaxial cable. Typically, the proximal section of the inner conductor of the cable connector is provided with a plurality of slots, so that the proximal section has a plurality of elastic fingers which, like springs, clamp the free end of the inner conductor of the coaxial cable received in the receiving hole. U.S. Pat. No. 7,249,969B2 provides an example of such a configuration.

In order to ensure sufficient elasticity and clamping force of the elastic fingers, the inner conductor of the cable connector is usually made of an expensive material such as phosphor bronze or beryllium bronze. According to the current knowledge level in cable connector technology, lead brass is typically deemed unsuitable as a material of a solder-free inner conductor of a cable connector, since lead brass has poorer elastic properties and lower yield strength than phosphor bronze or beryllium bronze.

### SUMMARY OF THE INVENTION

An object of the disclosure is to provide a cable connector for a coaxial cable, in which lead brass may be surprisingly used as a material for a solder-free inner conductor of the cable connector, and reliable connection between the coaxial cable and the cable connector may be ensured.

It is also an object of the disclosure to provide a coaxial cable assembly including such a cable connector and a method for manufacturing the coaxial cable assembly.

According to a first aspect of the invention, there is proposed a cable connector for a coaxial cable including: an inner conductor having a proximal section with a receiving hole configured to receive a free end of an inner conductor of a coaxial cable; an outer conductor having a distal chamber and a proximal chamber configured to receive an end section of the coaxial cable; and an insulator for insulating the inner conductor from the outer conductor of the cable connector, the insulator being received in the distal chamber wherein at least the proximal section of the inner conductor of the cable connector comprises lead brass, and the proximal section is configured to be crimped onto the free end of the inner conductor of the coaxial cable.

The invention surprisingly achieves a cable connector that may be manufactured more cheaply, and a reliable connection between the coaxial cable and the cable connector may be ensured, and the PIM (Passive Intermodulation) performance of a jumper line may also be ensured.

In some embodiments, the entire inner conductor of the cable connector may be made of lead brass.

In some embodiments, the inner conductor of the cable connector may be integral or in multi-parts. For example, it may be composed of two parts, one of which constitutes a distal section of the inner conductor and the other constitutes a proximal section of the inner conductor, and the two parts may be screwed or may be connected by a press fit.

In some embodiments, the proximal section of the inner conductor of the cable connector may be configured to be pressed with a crimping tool with the receiving hole receiving the free end of the inner conductor of the coaxial cable, so that after crimping the receiving hole is in interference fit with the free end of the inner conductor of the coaxial cable. The receiving hole can be in clearance fit with the free end of the inner conductor of the coaxial cable before the crimping operation.

Because of the poor elasticity of lead brass, the inner conductor of the cable connector may not be easy to deform and loosen after a crimping operation, so the connection between the inner conductor of the coaxial cable and the inner conductor of the cable connector may be more reliable, which can ensure the PIM (Passive Intermodulation) performance of a juniper line, for example.

In some embodiments, the proximal section of the inner conductor of the cable connector may have a circular cross-section after a crimping operation. This may be beneficial to the stabilization and improvement of the radio frequency (RF) performance of the cable connector.

In some embodiments, the proximal section of the inner conductor of the cable connector may not be slotted, or may be provided with one or more slots.

In some embodiments, the proximal section of the inner conductor of the cable connector may be slotted, and the proximal section may be pressed by the insulator when the inner conductor of the cable connector is inserted into the insulator.

In some embodiments, the proximal section of the inner conductor of the cable connector may be provided with a plurality of slots, which may be distributed in a circumferential direction of the inner conductor of the cable connector, for example in a uniform manner.

In some embodiments, the proximal section of the inner conductor of the cable connector may have a protrusion on an outer circumferential surface.

In some embodiments, as the protrusion, the proximal section of the inner conductor of the cable connector may have at least one annular rib, such as a plurality of ribs spaced apart from each other in an axial direction.

In some embodiments, the rib may have a height of 0.1 to 0.4 mm, such as 0.2 mm or 0.3 mm.

In some embodiments, the inner conductor of the cable connector may have a proximal flange, which may define an axial position of the inner conductor relative to the insulator of the cable connector.

In some embodiments, the outer conductor of the cable connector may be made of lead brass.

In some embodiments, the proximal chamber of the outer conductor of the cable connector may be configured to receive a solder material for soldering the outer conductor of the coaxial cable in the proximal chamber.

In some embodiments, the cable connector may include a flexible sleeve that can be placed onto a proximal section of the outer conductor of the cable connector defining the proximal chamber and that is configured to cover a section of the coaxial cable. The sleeve may be beneficial to the performance of the coaxial cable resistant to a bending load.

According to a second aspect of the invention, there is proposed a coaxial cable assembly including a coaxial cable and the cable connector for a coaxial cable according to the first aspect of the invention, the coaxial cable being connected with the cable connector.

In some embodiments, the coaxial cable may be a corrugated coaxial cable, wherein the outer conductor of the coaxial cable is a corrugated outer conductor.

In some embodiments, the proximal chamber of the outer conductor of the cable connector can receive a solder material in the form of a solder wire, a solder ring or a solder preform, which forms a soldering connection between the outer conductor of the cable connector and the outer conductor of the coaxial cable after melted and cured.

According to a third aspect of the present invention, there is proposed a method for manufacturing a coaxial cable assembly, said method including the following steps:
providing a coaxial cable, wherein in an end section of the coaxial cable, an inner conductor of the coaxial cable has a free end protruding axially and a sheath of the coaxial cable is at least partially removed to expose an outer conductor of the coaxial cable;
providing a cable connector for a coaxial cable;
placing a flexible sleeve and a solder material onto the coaxial cable;
placing a proximal section of the inner conductor of the cable connector onto the free end of the inner conductor of the coaxial cable, and crimping the proximal section of the inner conductor of the cable connector;
inserting the inner conductor of the cable connector into an insulator of the cable connector;
placing the solder material into the proximal chamber of the cable connector, melting and curing the solder material to solder the outer conductor of the coaxial cable in the proximal chamber; and
placing the flexible sleeve onto a proximal section of the outer conductor of the cable connector defining the proximal chamber, wherein the flexible sleeve covers a section of the coaxial cable.

According to a fourth aspect of the present invention, there is proposed a method for manufacturing a coaxial cable assembly, the method including the following steps:
providing a coaxial cable, wherein in an end section of the coaxial cable, an inner conductor of the coaxial cable has a free end protruding axially and a sheath of the coaxial cable is at least partially removed to expose an outer conductor of the coaxial cable;
providing a cable connector for a coaxial cable;
placing a flexible sleeve and a solder material onto the coaxial cable;
placing a proximal section of the inner conductor of the cable connector onto the free end of the inner conductor of the coaxial cable;
inserting the inner conductor of the cable connector into an insulator of the cable connector, wherein the proximal section is pressed by the insulator;
placing the solder material into the proximal chamber of the cable connector, melting and curing the solder material to solder the outer conductor of the coaxial cable in the proximal chamber; and
placing the flexible sleeve onto a proximal section of the outer conductor of the cable connector defining the proximal chamber, wherein the flexible sleeve covers a section of the coaxial cable.

Above-mentioned technical features, technical features to be mentioned below and technical features that can be obtained in the drawings can be arbitrarily combined with each other as long as they are not contradictory. All technically feasible feature combinations are technical contents contained in the disclosure.

### BRIEF DESCRIPTION OF DRAWINGS

The present invention will be described in detail by way of examples with reference to the accompanying drawings. Among them:

FIG. 1 is a longitudinal sectional view of a coaxial cable assembly according to a first embodiment of the invention.

FIGS. 2A and 2B are longitudinal sectional views of an inner conductor of a cable connector according to an embodiment of the invention before and after a crimping operation.

FIGS. 3A and 3B are longitudinal sectional views of an inner conductor of a cable connector according to another embodiment of the invention before and after a crimping operation.

FIG. 4 is a longitudinal sectional view of a coaxial cable assembly according to a second embodiment of the invention.

FIGS. 5 and 6 are a longitudinal sectional view and a side view of an inner conductor of a cable connector according to an embodiment of the invention.

FIG. 7 is a longitudinal sectional view of a coaxial cable assembly according to a third embodiment of the invention.

FIG. 8 is a longitudinal sectional view of a coaxial cable assembly according to a fourth embodiment of the invention.

In the figures, identical or functionally identical components are provided with the same reference numerals.

### EMBODIMENTS

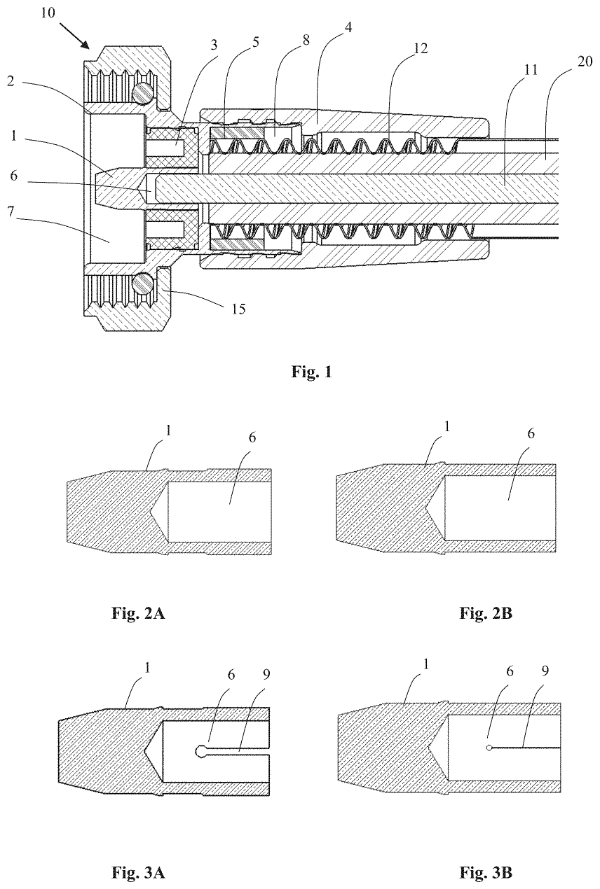

FIG. 1 is a longitudinal sectional view of a coaxial cable assembly according to a first embodiment of the invention, which may include a coaxial cable 20 and a cable connector 10. The coaxial cable 20 is connected with the cable connector 10 and may be connected with another coaxial cable or equipment by means of a pair of cable connectors mated together. In FIG. 1, the coaxial cable 20 is only illustrated in a partial length. In principle, the coaxial cable 20 may have any length, and may be provided with respective cable connectors in both end sections thereof. The coaxial cable 20 may include an inner conductor 11, an outer conductor 12, an insulating layer between the inner conductor and the outer conductor, and a sheath. The coaxial cable 20 may be, for example, a corrugated coaxial cable in which the outer conductor 12 is a corrugated outer conductor, or the outer conductor 12 may have a smooth profile.

The cable connector 10 may include an inner conductor 1, an outer conductor 2, and an insulator 3 for insulating the inner conductor 1 from the outer conductor 2. The inner conductor 1 has a proximal section with a receiving hole 6 which receives a free end of the inner conductor 11 of the coaxial cable 20. At least the proximal section of the inner conductor 1 may comprise lead brass, and in some embodiments the entire inner conductor 1 may be made of lead brass. The outer conductor 2 may be made of lead brass, stainless steel or other suitable materials. The outer conductor 2 may have a distal chamber 7 and a proximal chamber 8. The insulator 3 is received in the distal chamber 7. For example, the insulator 3 may be made of polytetrafluoroethylene, or may be made of TPX plastic which is inexpensive and can be injection-molded. The proximal chamber 8 receives an end section of the coaxial cable 20. As shown in FIG. 1, the cable connector 10 may further include a coupling nut 15 radially outside the outer conductor 2. Because of the shape of the inner conductor 1, the cable connector 10 may be deemed as a male connector. The male connector can be matched with a female connector to form a pair of connectors. For example, an individual coaxial cable may have one male connector and one female connector in the two end sections thereof, or may have two identical connectors.

FIGS. 2A and 2B are longitudinal sectional views of an inner conductor 1 of a cable connector according to an embodiment of the invention before and after a crimping operation. The inner conductor 1 may be used in the cable connector 10 as shown in FIG. 1. The inner conductor 1 shown in FIG. 2A is not slotted in a proximal section. The proximal section of the inner conductor 1 may be pressed and deformed by a crimping tool, so that the proximal section of the inner conductor 1 can firmly grasp the free end of the inner conductor 11 of the coaxial cable 20. The proximal section of the inner conductor 1 may have a circular cross-section before and after a crimping operation. Before the crimping operation, an inner diameter of the receiving hole 6 may be slightly larger than a diameter of the inner conductor 11 of the coaxial cable 20, so that the receiving hole 6 is in clearance fit with the inner conductor 11. After the crimping operation, the receiving hole 6 is in interference fit with the inner conductor 11.

FIGS. 3A and 3B are longitudinal sectional views of an inner conductor 1 of a cable connector according to another embodiment of the invention before and after a crimping operation. This embodiment differs from the embodiment of FIGS. 2A and 2B mainly in that the inner conductor 1 is provided with two slots 9 in the proximal section. The two slots 9 are arranged diametrically opposite to each other. After the crimping operation, the two slots 9 are substantially closed. The inner conductor 1 shown in FIGS. 3A and 3B may be used for the cable connector 10 shown in FIG. 1.

The proximal chamber 8 of the outer conductor 2 of the cable connector 10 may receive a solder material 5 in addition to the end section of the coaxial cable 20. In the embodiment shown in FIG. 1, the solder material 5 is configured as a solder ring, which is received in an annular space between a wall of the proximal chamber 8 and the outer conductor 12 of the coaxial cable 20. The solder ring shown in FIG. 1 is in an original state. A sound soldering connection between the outer conductor 2 and the outer conductor 12 can be established after the solder ring is melted and cured in a soldering operation. During the soldering process, the cable connector 10 and the coaxial cable 20 may be oriented substantially vertically.

The cable connector 10 may include a flexible sleeve 4 that is placed onto a proximal section of the outer conductor 2 of the cable connector 10 which defines the proximal chamber 8 and that covers a section of the coaxial cable. By means of the sleeve 4, the performance of the coaxial cable 20 resistant to a bending load in the region of the cable connector 10 may be improved. In order to firmly hold the sleeve 4 on the outer conductor 2, the outer conductor 2 may have an uneven structure on its proximal section.

A coaxial cable assembly as shown in FIG. 1 may be manufactured as follows, for example:
providing a coaxial cable 20, wherein in an end section of the coaxial cable 20, for example by cutting and stripping the sheath, the inner conductor 11 of the coaxial cable 20 has a free end protruding axially, and a sheath of the coaxial cable 20 is at least partially removed to expose the outer conductor 12;
providing a cable connector 10;
placing a flexible sleeve 4 and a solder ring as a solder material 5 onto the coaxial cable 20;
placing a proximal section of the inner conductor 1 of the cable connector 10 onto the free end of the inner conductor 11 of the coaxial cable 20, and pressing the proximal section of the inner conductor 1 of the cable connector 10 by a crimping tool;
inserting the inner conductor 1 of the cable connector 10 into the insulator 3 of the cable connector 10;
placing the solder ring as the solder material 5 into the proximal chamber 8 of the cable connector 10, and melting and curing the solder material 5 to form a soldering connection between the outer conductor 12 of the coaxial cable 20 and the outer conductor 2 of the cable connector 10; and
placing the flexible sleeve 4 onto a proximal section of the outer conductor 2 of the cable connector 10 defining the proximal chamber 8, wherein the sleeve 4 also covers a section of the coaxial cable 20.

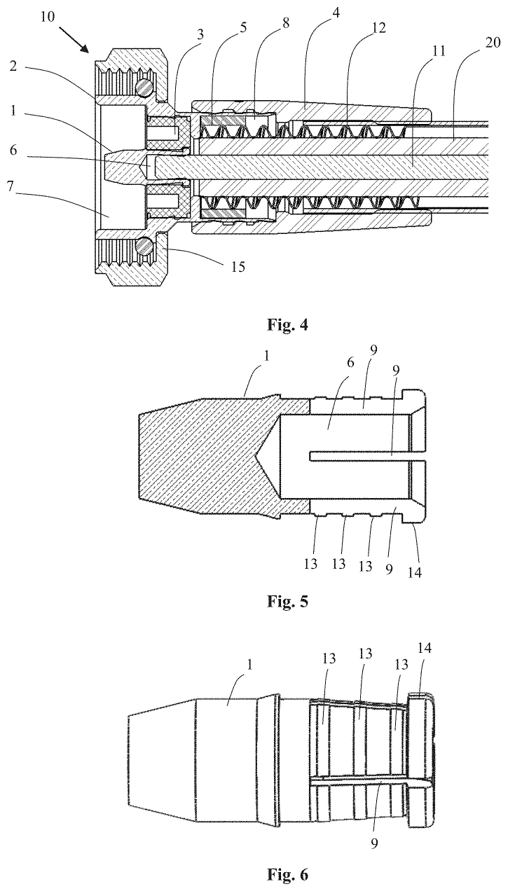

FIG. 4 is a longitudinal sectional view of a coaxial cable assembly according to a second embodiment of the invention. The difference between the embodiment of FIG. 4 and the embodiment of FIG. 1 mainly lies in the different constitution of the inner conductor 1 of the cable connector 10. In other respects, reference may be made to the description of the first embodiment. FIGS. 5 and 6 are a longitudinal sectional view and a side view of an inner conductor 1 of a cable connector according to an embodiment of the invention, which may be used for the cable connector 10 as shown in FIG. 4.

The inner conductor 1 shown in FIGS. 5 and 6 is provided with four slots 9 in the proximal section, which are uniformly distributed in a circumferential direction of the inner conductor 1; in other words, they have an angular distance of 90 degrees. When the inner conductor 1 is inserted into the insulator 3, the proximal section of the inner conductor 1 is pressed by the insulator 3, so that the proximal section of the inner conductor 1 can grasp the free end of the inner conductor 11 of the coaxial cable 20. Although the grasping force of the inner conductor 1 on the coaxial cable 20 may not be as high as that in the case of the crimping connection, it is still sufficient to ensure the reliability and stability of the electrical connection between the inner conductor 1 of the cable connector and the inner conductor 11 of the coaxial cable. In order to promote the pressing of the insulator 3 on the inner conductor 1, for example, the proximal section of the inner conductor 1 may have a protrusion on an outer circumferential surface. In some embodiments, as the aforementioned protrusion, the proximal section of the inner conductor 1 of the cable connector 10 may have at least one annular rib 13. In the embodiment shown in FIGS. 5 and 6, three annular ribs 13 are provided, which are spaced apart from each other in an axial direction. Since the proximal section of the inner conductor 1 is provided with four slots 9, each rib 13 is divided into four rib sections spaced apart from each other in a circumferential direction by these slots. Advantageously, the ribs may have a height of 0.1 to 0.4 mm, such as 0.2 mm, 0.25 mm or 0.3 mm. The inner conductor 1 of the cable connector 10 may further have a proximal flange 14 that may definitely define an axial position of the inner conductor 1 of the cable connector 10 relative to the insulator 3.

The coaxial cable assembly as shown in FIG. 4 may be manufactured as follows, for example:
providing a coaxial cable 20, wherein in an end section of the coaxial cable 20, for example by cutting and stripping the sheath, an inner conductor 11 of the coaxial cable 20 has a free end protruding axially and a sheath of the coaxial cable 20 is at least partially removed to expose an outer conductor 12;
providing a cable connector 10;
placing a flexible sleeve 4 and a solder ring as a solder material 5 onto the coaxial cable;
placing a proximal section of the inner conductor 1 of the cable connector 10 onto the free end of the inner conductor 11 of the coaxial cable 20;
inserting the inner conductor 1 of the cable connector 10 into the insulator 3 of the cable connector 10, wherein the proximal section of the inner conductor 1 is pressed by the insulator 3 so that the proximal section of the inner conductor 1 grasps the free end of the inner conductor 11 of the coaxial cable 20;
placing the solder ring into the proximal chamber 8 of the cable connector 10. and melting and curing the solder material 5 to form a soldering connection between the outer conductor 12 of the coaxial cable 20 and the outer conductor 2 of the cable connector 10; and
placing the flexible sleeve 4 onto a proximal section of the outer conductor 2 of the cable connector 10 defining the proximal chamber 8, wherein the sleeve 4 also covers a section of the coaxial cable 20.

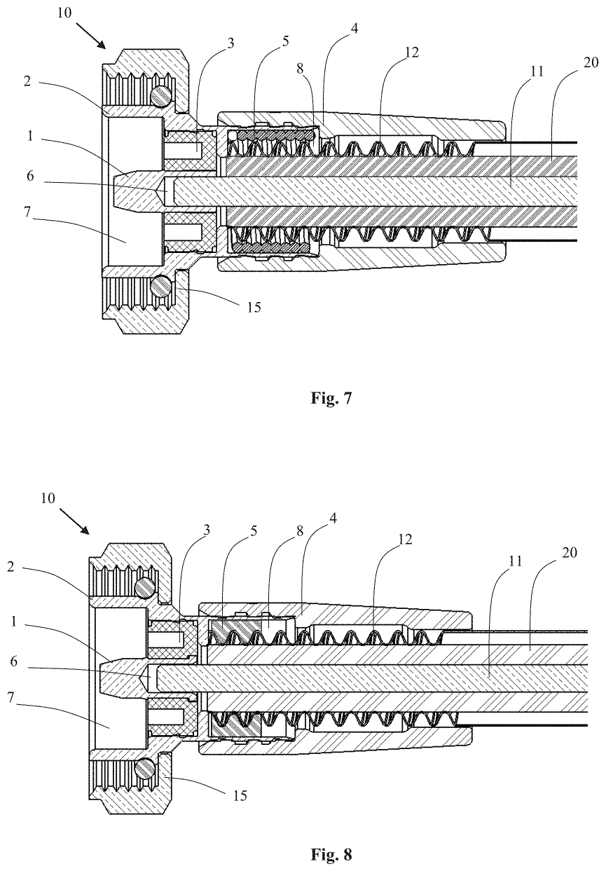

FIG. 7 is a longitudinal sectional view of a coaxial cable assembly according to a third embodiment of the invention. This embodiment is similar to the first embodiment shown in FIG. 1, and the main difference is that a solder wire is used as the solder material 5. Other respects may be the same as or similar to those in the first embodiment. The solder wire may be wound into a spiral piece, for example.

FIG. 8 is a longitudinal sectional view of a coaxial cable assembly according to a fourth embodiment of the invention. This embodiment is similar to the second embodiment shown in FIG. 4, and the main difference is that a solder preform is used as the solder material 5. Other respects may be the same as or similar to those in the second embodiment.

It will be understood that the terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprise” and “include” (and variants thereof), when used in this specification, specify the presence of stated operations, elements, and/or components, but do not preclude the presence or addition of one or more other operations, elements, components, and/or groups thereof. As used herein, the term “and/or” includes any and all combinations of one or more of the associated listed items. Like reference numbers signify like elements throughout the description of the figures.

The thicknesses of elements in the drawings may be exaggerated for the sake of clarity. Further, it will be understood that when an element is referred to as being “on,” “coupled to” or “connected to” another element, the element may be formed directly on, coupled to or connected to the other element, or there may be one or more intervening elements therebetween. In contrast, terms such as “directly on,” “directly coupled to” and “directly connected to,” when used herein, indicate that no intervening elements are present. Other words used to describe the relationship between elements should be interpreted in a like fashion (i.e., “between” versus “directly between”, “attached” versus “directly attached,” “adjacent” versus “directly adjacent”, etc.).

Terms such as “top,” “bottom,” “upper,” “lower,” “above,” “below,” and the like are used herein to describe the relationship of one element, layer or region to another element, layer or region as illustrated in the figures. It will be understood that these terms are intended to encompass different orientations of the device in addition to the orientation depicted in the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive concept.

It will also be appreciated that all example embodiments disclosed herein can be combined in any way.

Finally, it is to be noted that, the above-described embodiments are merely for understanding the present invention but not constitute a limit on the protection scope of the present invention. For those skilled in the art, modifications may be made on the basis of the above-described embodiments, and these modifications do not depart from the protection scope of the present invention.

What is claimed is:

1. A cable connector for a coaxial cable including:
an inner conductor having a proximal section with a receiving hole configured to receive a free end of an inner conductor of a coaxial cable;
an outer conductor having a distal chamber and a proximal chamber configured to receive an end section of the coaxial cable; and
an insulator for insulating the inner conductor from the outer conductor of the cable connector, the insulator being received in the distal chamber;
wherein at least the proximal section of the inner conductor of the cable connector comprises lead brass, and the proximal section is configured to be crimped onto the free end of the inner conductor of the coaxial cable.

2. The cable connector for a coaxial cable as recited in claim 1, wherein the entire inner conductor of the cable connector is made of lead brass.

3. The cable connector for a coaxial cable as recited in claim 1, wherein the proximal section of the inner conductor of the cable connector is configured to be pressed by a crimping tool with the receiving hole receiving the free end of the inner conductor of coaxial cable, so that after crimping the receiving hole is in interference fit with the free end of the inner conductor of coaxial cable.

4. The cable connector for a coaxial cable as recited in claim 3, wherein the proximal section of the inner conductor of the cable connector has a circular cross-section after a crimping operation.

5. The cable connector for a coaxial cable as recited in claim 3, wherein the proximal section of the inner conductor of the cable connector is not slotted, or is provided with one or more slots.

6. The cable connector for a coaxial cable as recited in claim 1, wherein the proximal section of the inner conductor of the cable connector is slotted, and the proximal section is pressed by the insulator when the inner conductor of the cable connector is inserted into the insulator.

7. The cable connector for a coaxial cable as recited in claim 6, wherein the proximal section of the inner conductor of the cable connector is provided with a plurality of slots distributed in a circumferential direction of the inner conductor of the cable connector.

8. The cable connector for a coaxial cable as recited in claim 6, wherein the proximal section of the inner conductor of the cable connector has a protrusion on an outer circumferential surface.

9. The cable connector for a coaxial cables as recited in claim 8, wherein the proximal section of the inner conductor of the cable connector has at least one annular rib as the protrusion.

10. The cable connector for a coaxial cable as recited in claim 9, wherein the rib has a height of 0.1 to 0.4 mm.

11. The cable connector for a coaxial cable as recited in claim 6, wherein the inner conductor of the cable connector has a proximal flange which defines an axial position of the inner conductor of the cable connector relative to the insulator.

12. The cable connector for a coaxial cable as recited in claim 1, wherein the outer conductor of the cable connector is made of lead brass.

13. The cable connector for a coaxial cable as recited in claim 1, wherein the proximal chamber of the outer conductor of the cable connector is configured to receive a solder material for soldering the outer conductor of the coaxial cable in the proximal chamber.

14. The cable connector for a coaxial cable as recited in claim 1, wherein the cable connector includes a flexible sleeve, which can be placed onto a proximal section of the outer conductor of the cable connector defining the proximal chamber and which is configured to cover a section of the coaxial cable.

15. A coaxial cable assembly including a coaxial cable, wherein the coaxial cable assembly includes the cable connector for a coaxial cable as recited claim 1, wherein the coaxial cable is connected with the cable connector.

16. The coaxial cable assembly as recited in claim 15, wherein the coaxial cable is a corrugated coaxial cable, wherein the outer conductor of the coaxial cable is a corrugated outer conductor.

17. The coaxial cable assembly as recited in claim 16, wherein the proximal chamber of the outer conductor of the cable connector can receive a solder material in the form of a solder wire, a solder ring or a solder preform, and the solder material forms a soldering connection between the outer conductor of the cable connector and the outer conductor of the coaxial cable after melted and cured.

18. A method for manufacturing a coaxial cable assembly, the method including the following steps:
providing a coaxial cable, wherein in an end section of the coaxial cable, an inner conductor of the coaxial cable has a free end protruding axially and a sheath of the coaxial cable is at least partially removed to expose an outer conductor of the coaxial cable;
providing the cable connector for a coaxial cable as recited in claim 3;
placing a flexible sleeve and a solder material onto the coaxial cable;
placing the proximal section of the inner conductor of the cable connector onto the free end of the inner conductor of the coaxial cable, and crimping the proximal section of the inner conductor of the cable connector;
inserting the inner conductor of the cable connector into the insulator of the cable connector;
placing the solder material into the proximal chamber of the cable connector, melting and curing the solder material to solder the outer conductor of the coaxial cable in the proximal chamber; and
placing the flexible sleeve onto a proximal section of the outer conductor of the cable connector defining the proximal chamber, wherein the flexible sleeve covers a section of the coaxial cable.

19. A method for manufacturing a coaxial cable assembly, the method including the following steps:
providing a coaxial cable, wherein in an end section of the coaxial cable, an inner conductor of the coaxial cable has a free end protruding axially and a sheath of the coaxial cable is at least partially removed to expose an outer conductor of the coaxial cable
providing the cable connector for a coaxial cable as recited in claim 6;
placing a flexible sleeve and a solder material onto the coaxial cable;
placing the proximal section of the inner conductor of the cable connector onto the free end of the inner conductor of the coaxial cable;
inserting the inner conductor of the cable connector into the insulator of the cable connector, wherein the proximal section is pressed by the insulator;
placing the solder material into the proximal chamber of the cable connector, melting and curing the solder material to solder the outer conductor of the coaxial cable in the proximal chamber; and
placing the flexible sleeve onto the proximal section of the outer conductor of the cable connector defining the proximal chamber, wherein the flexible sleeve covers a section of the coaxial cable.
